(19) United States
(12) Patent Application Publication
(10) Pub. No.: US 2003/0006995 A1
(43) Pub. Date: Jan. 9, 2003

(54) Orthogonal magnifier within a computer system display

(76) Inventors: Randall B. Smith, Palo Alto, CA (US); Achut Reddy, Mountain View, CA (US); Helen A. Cunningham, Los Altos Hills, CA (US)

Correspondence Address: PARK, VAUGHAN & FLEMING LLP, 508 SECOND STREET, SUITE 201, DAVIS, CA, 95616, US

(21) Appl. No.: 09/882,844

(22) Filed: Jun. 15, 2001

(51) Int. Cl. G09G 5/00

(52) U.S. Cl. 345/671

(57) ABSTRACT

One embodiment of the present invention provides a system that selectively magnifies a region within a computer display without obscuring proximate regions in the computer display. The system operates by receiving positioning information from a user of a computer system, wherein the positioning information determines a position of a magnifier within the computer display. Next, the system positions the magnifier over the target region and over proximate regions in the computer display. The system then displays the target region within the magnifier in magnified form, and displays the proximate regions within the magnifier in reduced and/or partially magnified form, so that features within the proximate regions are visible within the magnifier and are not obscured by the magnifier. The system also displays regions within the computer display not covered by the magnifier in unmodified form.

### COPYRIGHT NOTICE

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND

1. Field of the Invention

The present invention relates to user interfaces for computer systems. More particularly, the present invention relates to a method and an apparatus for selectively magnifying a target region within a computer display by placing a magnifier over the target region, wherein the magnifier does not obscure other regions in the computer display.

2. Related Art

As the processing power and the data storage capacity of computer systems both continue to increase at an exponential rate, it is becoming progressively easier to store and to manipulate large data sets within a computer system. However, it can be a challenge to scan through and view such large data sets in an efficient manner because of the limited space that is available on a typical computer display.

A standard viewing technique is to provide one or two-dimensional scrolling. However, it can be quite challenging to locate a specific object in such scrolling systems because only a small portion of the display space is visible at any given time.

This problem can be remedied by using a “context map,” which displays a large portion of the display space at a lower resolution along with a “magnified view,” which displays a smaller portion of the display space at a higher resolution. This context map allows a user to navigate the magnified view to specific regions within the display space. Unfortunately, since the context map is typically off to one side of the display, the process of navigating the magnified view to a specific location on the context map is somewhat cumbersome and unintuitive.

A number of researchers have investigated distortion-oriented techniques to view and scan through data in one or more dimensions. For example, see “Review and Taxonomy of Distortion-Oriented Presentation Techniques,” by Y. K. Leung and M. D. Apperley, and article on pages 350-367 of “Readings in Information and Visualization Using Vision to Think,” edited by Stuart K. Card, Jock D. Mackinlay and Ben Shneiderman, Morgan Kaufmann Publishers, Inc., San Francisco, Calif., 1999. The problem with a distortion-oriented display is that the distortion can be very severe around the edges, so the context cannot be easily interpreted, and it is difficult to create two or more areas of focus with the distortion view.

One way to remedy this navigation problem is to present the magnified view as a simulated magnifying lens that can be moved around within a lower-resolution map of the display space. In this way, a target region of the display space can be viewed in magnified form by simply moving the magnifying lens over the target region (see FIG. 3). Note that in a simulated magnifying lens, an area outside the lens remains undistorted. Furthermore, it is possible to provide multiple lenses on a screen.

However, when a user moves the lens over the target region, a portion of the display space immediately surrounding the magnified target region is not visible. For example, with a circular lens, there is a ring-shaped region beneath the lens, surrounding the magnified zone, which is neither visible within the lens, nor in the rest of the display. This can make it difficult to navigate a lens toward a target region, especially if the lens provides a higher power of magnification.

What is needed is a method and an apparatus for selectively magnifying a target region directly within a computer system display without obscuring proximate regions.

### SUMMARY

One embodiment of the present invention provides a system that selectively magnifies a region within a computer display without obscuring proximate regions in the computer display. The system operates by receiving positioning information from a user of a computer system, wherein the positioning information determines a position of a magnifier within the computer display. Next, the system positions the magnifier over the target region and over proximate regions in the computer display. The system then displays the target region within the magnifier in magnified form, and displays the proximate regions within the magnifier in reduced and/or partially magnified form, so that features within the proximate regions are visible within the magnifier and are not obscured by the magnifier. The system also displays regions within the computer display not covered by the magnifier in unmodified form.

In one embodiment of the present invention, upon receiving a command to adjust magnification, the system adjusts the magnification of the target region within the magnifier.

In one embodiment of the present invention, the positioning information is received from a pointing device in the computer system, so that the pointing device can be used to position the magnifier within the computer display.

In one embodiment of the present invention, the magnifier is a window that moves about the computer display.

In a variation on this embodiment, the magnifier is organized as a grid with 21 regions, including: a central region; a top left region, which is above and to the left of the central region; a top middle region, which is above the central region; a top right region, which is above and to the right of the central region; a middle left region, which is to the left of the central region; a middle right region, which is to the right of the central region; a bottom left region, which is below and to the left of the central region; a bottom middle region, which is below the central region; a bottom right region, which is below and to the right of the central region. The 21 regions in the grid also include 12 peripheral regions, including a top left peripheral region, which is above the top left region; a top middle peripheral region, which is above the top middle region; a top right peripheral region, which is above the top right region; a left top peripheral region, which is to the left of the top left region; a left middle peripheral region, which is to the left of the middle left region; a left bottom peripheral region, which is to the left of the bottom left region; a right top peripheral region, which is to the right of the top right region; a right middle peripheral region, which is to the right of the middle right region; a right bottom peripheral region, which is to the right of the bottom right region; a bottom left peripheral region, which is below the bottom left region; a bottom middle peripheral region, which is below the bottom middle region; and a bottom right peripheral region, which is below the bottom right region.

In a variation on this embodiment, the central region magnifies in both the vertical and horizontal directions; the top left region reduces in the vertical direction and reduces in the horizontal direction; the top middle region reduces in the vertical direction and magnifies in the horizontal direction; the top right region reduces in the vertical direction and reduces in the horizontal direction; the middle left region magnifies in the vertical direction and reduces in the horizontal direction; the middle right region magnifies in the vertical direction and reduces in the horizontal direction; the bottom left region reduces in the vertical direction and reduces in the horizontal direction; the bottom middle region reduces in the vertical direction and magnifies in the horizontal direction; the bottom right region reduces in the vertical direction and reduces in the horizontal direction; the top left peripheral region reduces in the horizontal direction; the top middle peripheral region magnifies in the horizontal direction; the top right peripheral region reduces in the horizontal direction; the left top peripheral region reduces in the vertical direction; the left middle peripheral region magnifies in the vertical direction; the left bottom peripheral region reduces in the vertical direction; the right top peripheral region reduces in the vertical direction; the right middle peripheral region magnifies in the vertical direction; the right bottom peripheral region reduces in the vertical direction; the bottom left peripheral region reduces in the horizontal direction; the bottom middle peripheral region magnifies in the horizontal direction; and the bottom right peripheral region reduces in the horizontal direction. In this variation, the twelve peripheral regions do not magnify or reduce as much as the proximate regions.

In a variation on this embodiment, the magnifier is organized as a grid with nine regions, including: a central region; a top left region, which is above and to the left of the central region; a top middle region, which is above the central region; a top right region, which is above and to the right of the central region; a middle left region, which is to the left of the central region; a middle right region, which is to the right of the central region; a bottom left region, which is below and to the left of the central region; a bottom middle region, which is below the central region; and a bottom right region, which is below and to the right of the central region.

In a variation on this embodiment, the central region magnifies in both the vertical and horizontal directions; the top left region reduces in the vertical direction and reduces in the horizontal direction; the top middle region reduces in the vertical direction and magnifies in the horizontal direction; the top right region reduces in the vertical direction and reduces in the horizontal direction; the middle left region magnifies in the vertical direction and reduces in the horizontal direction; the middle right region magnifies in the vertical direction and reduces in the horizontal direction; the bottom left region reduces in the vertical direction and reduces in the horizontal direction; the bottom middle region reduces in the vertical direction and magnifies in the horizontal direction; and the bottom right region reduces in the vertical direction and reduces in the horizontal direction.

In one embodiment of the present invention, displaying the target region involves invoking a display method of an object associated with the target region, wherein this display method uses a magnification transformation to magnify the target region.

In one embodiment of the present invention, the system includes a second magnifier that magnifies a second target region in the computer display.

### BRIEF DESCRIPTION OF THE FIGURES

FIG. 1 illustrates a computer system with an orthogonal magnifier in accordance with an embodiment of the present invention.

FIG. 2A illustrates the structure of an orthogonal magnifier in accordance with an embodiment of the present invention.

FIG. 2B illustrates the structure of an orthogonal magnifier in accordance with another embodiment of the present invention.

FIG. 3 illustrates how an example magnifier operates in accordance with an embodiment of the present invention.

FIG. 4 illustrates how the orthogonal magnifier operates in accordance with an embodiment of the present invention.

FIG. 5 is a flow chart illustrating how the orthogonal magnifier operates in accordance with an embodiment of the present invention.

FIG. 6 is a flow chart illustrating operation of a second orthogonal magnifier in accordance with an embodiment of the present invention.

FIG. 7 illustrates two orthogonal magnifiers within a computer display in accordance with an embodiment of the present invention.

Table 1A presents a first section of a code listing to implement an orthogonal magnifier in accordance with an embodiment of the present invention.

Table 1B presents a second section of a code listing to implement the orthogonal magnifier in accordance with an embodiment of the present invention.

Table 1C presents a third section of a code listing to implement the orthogonal magnifier in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Computer System

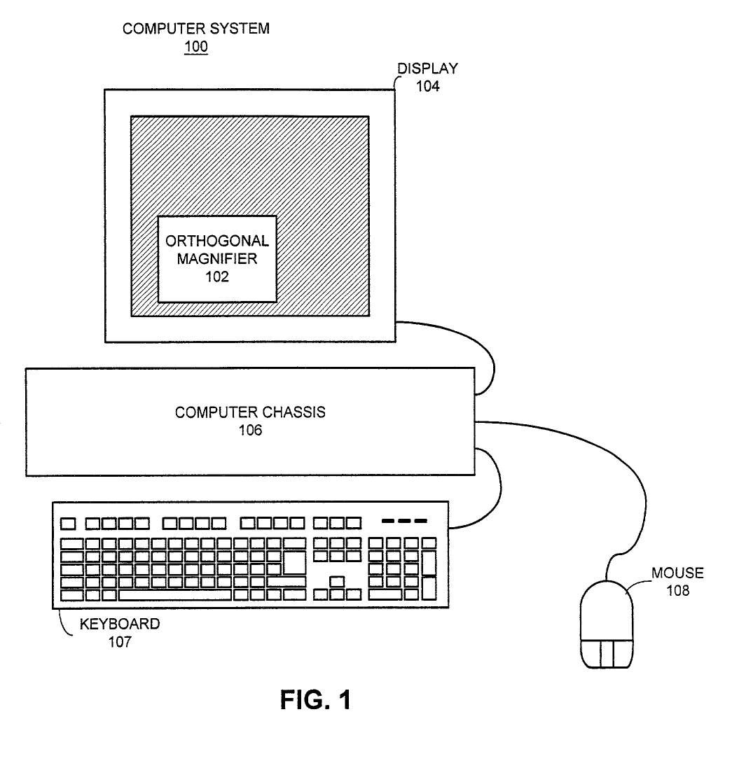

FIG. 1 illustrates a computer system 100 including an orthogonal magnifier 102 in accordance with an embodiment of the present invention. Computer system 100 can generally include any type of computer system, including, but not limited to, a computer system based on a microprocessor, a mainframe computer, a digital signal processor, a portable computing device, a personal organizer, a device controller, and a computational engine within an appliance.

In the embodiment illustrated in FIG. 1, computer system 100 includes a computer chassis 106, which receives input from both a keyboard 107 and a mouse 108. Computer system 100 outputs data graphical images to display 104, which includes orthogonal magnifier 102. Orthogonal magnifier 102 can be moved around display 104 through commands entered through mouse 108 and/or keyboard 107.

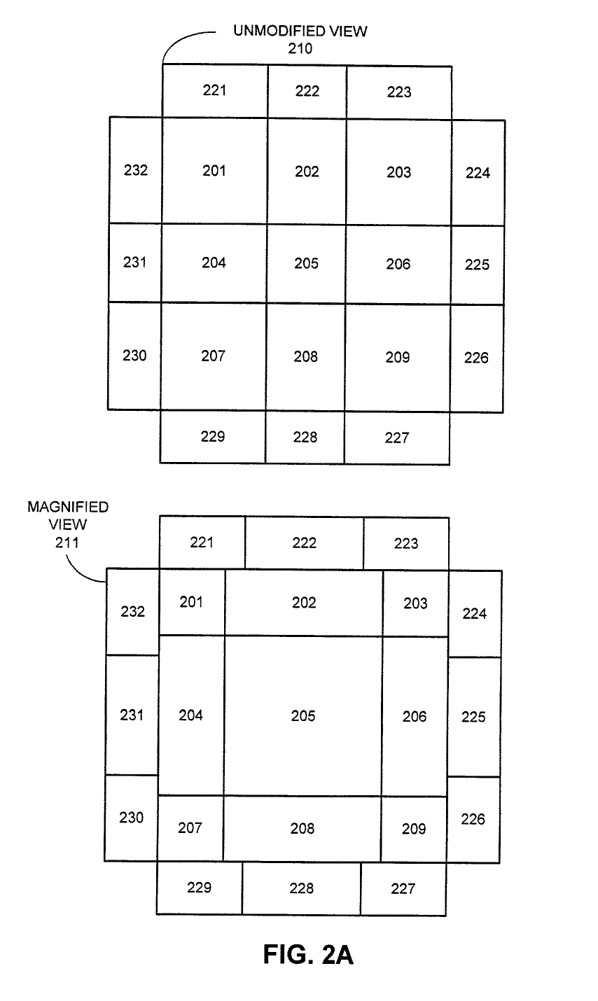

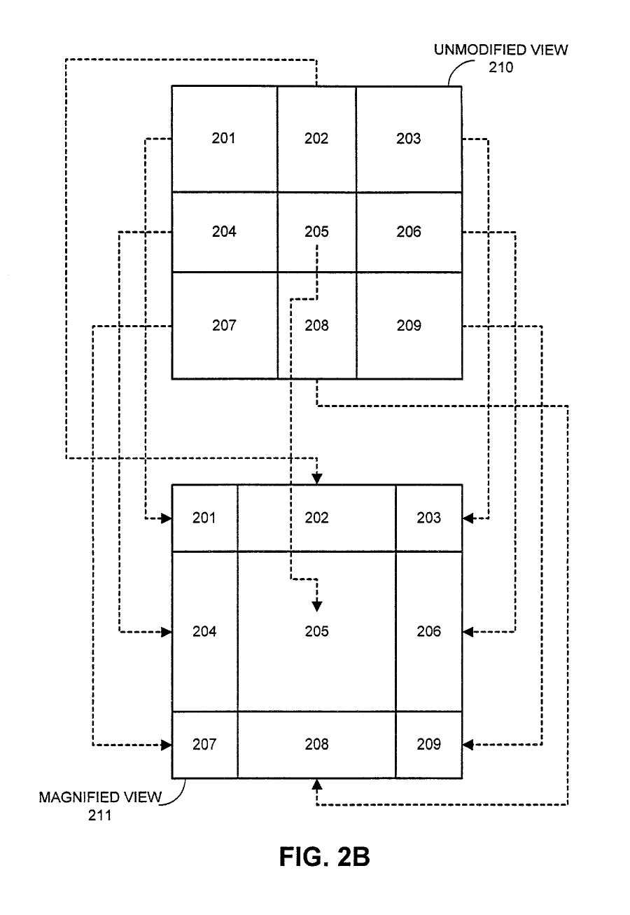

Orthogonal magnifier 102 magnifies a target region of display 104 that is located directly under orthogonal magnifier 102 without obscuring features in proximate regions covered by orthogonal magnifier 102. This is accomplished by reducing and/or partially magnifying features in the proximate regions as is described in more detail below with reference to FIGS. 2-6.

Orthogonal Magnifier

FIG. 2A illustrates how orthogonal magnifier 102 operates in accordance with an embodiment of the present invention. Orthogonal magnifier 102 starts off with an unmodified view 210, which is simply a region of display 104 that is covered by orthogonal magnifier 102.

Unmodified view 210 includes a target region 205 to be magnified, and proximate regions 201-204 and 206-209, and peripheral regions 221-232. Each of these regions is transformed and displayed in magnified view 211 as is illustrated in FIG. 2A. Target region 205, which is located at the center of unmodified view 210, is magnified in both the horizontal and vertical dimensions. Proximate regions 201, 203, 207 and 209, which are located at the corners of unmodified view 210, are reduced in both the horizontal and vertical dimensions. Proximate regions 202 and 208, which are located above and below target region 205 in unmodified view 210, are magnified in the horizontal dimension and reduced in the vertical dimension. Proximate regions 204 and 206, which are located to the left and right of target region 205 in unmodified view 210, are reduced in the horizontal dimension and magnified in the vertical dimension.

Peripheral regions 224, 226, 230 and 234 are not changed in the horizontal direction, but are reduced in the vertical direction. However, they are not reduced in the vertical direction as much as regions 201, 203, 209 and 207 are reduced. Peripheral regions 225 and 231 are not changed in the horizontal direction, but are magnified in the vertical direction. However, they are not magnified in the vertical direction as much as region 205 is magnified.

Peripheral regions 221, 221, 227 and 229 are not changed in the vertical direction, but are reduced in the horizontal direction. However, they are not reduced in the horizontal direction as much as regions 201, 203, 209 and 207 are reduced. Peripheral regions 222 and 228 are not changed in the vertical direction and, but are magnified in the horizontal direction. However, they are not magnified in the horizontal direction as much as region 205 is magnified.

Note that peripheral regions 221-232 are not as distorted as target region 205 or proximate regions 201-204 and 206-209. Hence, peripheral regions 221-232 provide a visual gradation between the more distorted interior regions 210-209 and the unmodified background.

Also note unlike a standard magnifying lens, the transformations illustrated in FIG. 2A do not occlude or otherwise obscure any features within proximate regions 201-204 and 206-209 and peripheral regions 221-232. These features are simply reduced in size or magnified in one dimension so that they remain visible in magnified view 211. Moreover, the transformations illustrated in FIG. 2A can be performed by simply applying twenty-one different affine transformations to the features on display 104. This is much more computationally efficient than other possible transformations.

FIG. 2A illustrates how another embodiment of orthogonal magnifier 102 operates. This embodiment operates in the same manner as the embodiment illustrated in FIG. 2B, except that the peripheral regions 221-232 of the orthogonal magnifier 102 of FIG. 2A are not present in the orthogonal magnifier of FIG. 2B. Only target region 205 and proximate regions 210-204 and 206-209 remain.

Although the present invention is described in terms of the transformations illustrated in FIG. 2A and FIG. 2B, the present invention is not meant to be limited to such as transformation. For example, any other transformation which does not occlude or otherwise obscure features in proximate regions under orthogonal magnifier 102 can be used. Furthermore, the present invention is not meant to be limited to a rectangular or square magnifier. Orthogonal magnifier 102 can generally be of any shape.

### EXAMPLES

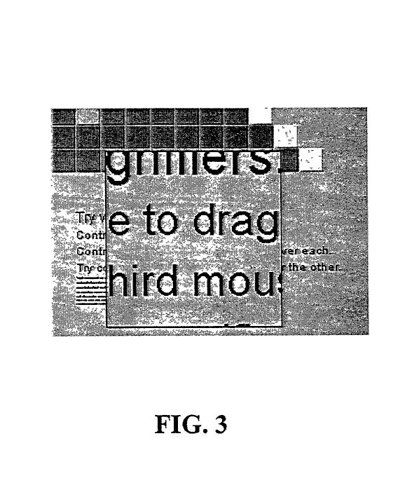

FIG. 3 illustrates how an example magnifier operates in accordance with an embodiment of the present invention. Note that this magnifier effectively magnifies text in the target region of the display. However, the magnified view covers up proximate regions of the display immediately surrounding the magnified region. At higher levels of magnification, this makes it hard to navigate the magnifier to a specific location within the display.

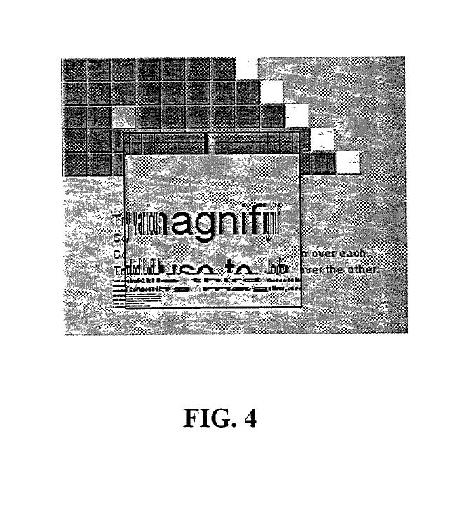

FIG. 4 illustrates how the orthogonal magnifier of FIG. 2B operates in accordance with an embodiment of the present invention. Note that text in the target region is effectively magnified. However, text located in proximate regions that immediately surround the target regions does not disappear. This text is simply reduced and/or magnified in one dimension to fit into the magnifier.

Operation of Orthogonal Magnifier

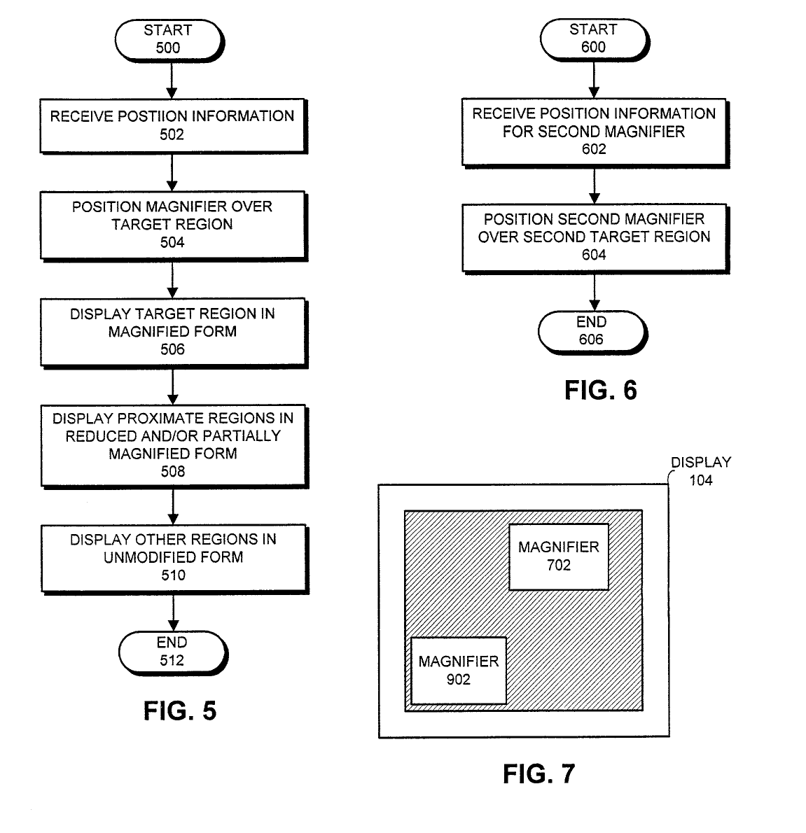

FIG. 5 is a flow chart illustrating how orthogonal magnifier 102 operates in accordance with an embodiment of the present invention. Computer system 100 first receives position information from a user through mouse 108 and/or keyboard 107 (step 502). In response to this position information, computer system 100 positions orthogonal magnifier 102 over a target region of display 104 (step 504). While orthogonal magnifier 102 is positioned over the target region 205 and proximate regions 201-204 and 206-209 of display 104, computer system 100 displays target region 205 in magnified form (step 506) and displays proximate regions 201-204 and 206-209 in reduced and/or magnified partially forms as is illustrated in FIG. 2 (step 508). Computer system 100 also displays other regions of display 104, which are not covered by orthogonal magnifier 102, in unmodified form (step 510).

Multiple Orthogonal Magnifiers

FIG. 6 is a flow chart illustrating operation of a second orthogonal magnifier in accordance with an embodiment of the present invention. In this embodiment, computer system 100 additionally receives position information for a second orthogonal magnifier (step 602), and then positions the second magnifier over a second target region of display 104 (step 604). This second magnifier operates in the same manner as the first magnifier, except that it magnifies the second target region.

FIG. 7 illustrates two orthogonal magnifiers 102 and 702 within a computer display 104 in accordance with an embodiment of the present invention. Note that each of the orthogonal magnifiers 102 and 702 can be positioned over a different target region within display 104.

Example Code

Tables 1A-1C below present an example code listing for a program that implements an orthogonal magnifier 102 as illustrated in FIG. 2B in accordance with an embodiment of the present invention.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

```
TABLE 1A
/*
  * @ (#) OrthogonalMagnifier.java  1.2 01/03/21
  * Copyright 1997-2001 Sun Microsystems, Inc. All Rights Reserved.
  * This software is the proprietary information of Sun
  * Microsystems, Inc. Use is subject to license terms.
  */
import javax.swing.*;
import java.awt.*;
import java.awt.event.*;
import java.awt.geom.*;
import java.lang.*;
import java.util.*;
public class OrthogonalMagnifier extends Magnifier {
```

| private Magnifier[] [] mags = new Magnifier [3] [3]; | |
|---|---|
| private double[] [] magXs; | // cache of magnification factors |
| private double[] [] magYs; | // for the various sub magnifiers |

private double magBorderFactorX = 0.2;
private double magBorderFactorY = 0.2;

OrthogonalMagnifier ( ) {

super( );

}
OrthogonalMagnifier(int w, int h, double m) {

this(w, h, m, m);

}
OrthogonalMagnifier(int x, int y, int w, int h, double m) {

this(x, y, w, h, m, m);

}
OrthogonalMagnifier(int w, int h, double mX, double mY) {

this(0, 0, w, h, mX, mY);

}
OrthogonalMagnifier(int x, int y, int w, int h, double mX,

double mY) {
this( );
init(x, y, w, h, mx, mY);

}

TABLE 1B
void init(int x, int y, int w, int h, double mX, double mY) {

mags [1] [1] = this;
for(int i=0; i<3; i++) {

for(int j=0; j<3; j++) {

if((i !=1) || (j != 1)) {

mags[i] [j] = new Magnifier(10, 10);
(mags [i] [j]).setShowBoundingRect(false);
this.add( mags[i] [j]);

}

}

}
adjustBorderMagnifiers(x, y, w, h);
super.init(x,y,w,h,mX,mY);

}
void setMagArrays(int w, int h, double mX, double mY) {

int mW = (int) (magBorderFactorX*w);
int mH = (int) (magBorderFactorY*h);
double w1 = (1.0 − 2*magBorderFactorX) * w;
double h1 = (1.0 − 2*magBorderFactorY) * h;
double bMagX = 2.0 * mW / (2.0*mW + w1*(1.0 − 1.0 / mX));
double bMagY = 2.0 * mH / (2.0*mH + h1*(1.0 − 1.0 / mY));
double litXs[] [] = { {bMagX, mX, bMagX}, {bMagX, mX, bMagX},

{bMagX, mX, bMagX} };

magXs = litXs;
double litYs[] [] = { {bMagY, bMagY, bMagY}, {mY, mY, mY},

{bMagY, bMagY, bMagY} };

magYs = litYs;

}
public void setMagnificationX(double m) {

super. setMagnificationX(m);
setMagArrays(getWidth ( ), getHeight ( ), m,

getMagnificationY( ));

if(mags != null) {

for(int i=0; i<3; i++) {

for(int j=0; j<3; j++) {

if(mags[i] [j] != this) {

mags[i] [j].setMagnificationX(magXs[i] [j]);

}

}

}

}

}

TABLE 1C

public void setMagnificationY(double m) {

super.setMagnificationY(m);
setMagArrays(getWidth( ) , getHeight ( ), getMagnificationX( ), m);
if(mags != null) {

for(int i=0; i<3; i++) {

for(int j=0; j<3; j++) {

if(mags[i] [j] != this) {

mags[i] [j].setMagnificationY(magYs[i] [j]);

}

}

}

}

}
public void setBounds(int x, int y, int w, int h) {

super.setBounds(x, y, w, h);
adjustBorderMagnifiers( x, y, w, h);
setMagnificationX(getMagnificationX( ));
setMagnificationY(getMagnificationY( ));

}
public void adjustBorderMagnifiers(int x,int y,int w,int h) {

int mW = (int) (magBorderFactorX*w);
int mH = (int) (magBorderFactorY*h);
int locXs[] []={ {0,mW,w−mW}, {0,mW,w−mW}, (0,mW,w−mW} };
int locYs[] []={ {0,0,0}, (mH,mH,mH}, {h−mH,h−mH,h−mH} };
int widths[] []={ {mW,w−2*mW,mW}, {mW,0,mW}, {mW,w−2*mW,mW} };
int heights[] []={ {mH,mH,mH}, {h−2*mH,0,h−2*mH}, (mH,mH,mH} };
double centerMapToXs[] [] = { {0.0, 0.5, 1.0},

{0.0, 0.5, 1.0}, {0.0, 0.5,1.0} };

double centerMapToYs[] [] = { {0.0, 0.0, 0.0},

{0.5, 0.5, 0.5}, {1.0, 1.0, 1.0} };

for(int i=0; i<3; i++) {

for(int j=0; j<3; j++) {

if((i != 1) || (j != 1)) {

mags[i] [j].setSize(widths[i] [i], heights[i] [j]);
mags[i] [j].setLocation(locXs[i] [j] , locYs[i] [j]);
mags[i] [j].setShowGlints(false);
mags[i] [j].setIsSelfDragging(false);
mags[i] [j].setCenterMapToX(centerMapToXs[i] [j]);
mags[i] [j].setCenterMapToY(centerMapToYs[i] [j]);

}

}

}

}

}

What is claimed is:

1. A method for selectively magnifying a region within a computer display without obscuring proximate regions in the computer display, comprising:
receiving positioning information from a user of a computer system;
wherein the positioning information determines a position of a magnifier within the computer display;
wherein the magnifier covers a target region to be magnified and proximate regions immediately surrounding the target region;
positioning the magnifier over the target region and the proximate regions in the computer display;
displaying the target region within the magnifier in magnified form;
displaying the proximate regions within the magnifier in reduced and/or partially magnified form, so that features within the proximate regions are not obscured by the magnifier; and
displaying regions within the computer display not covered by the magnifier in unmodified form.

2. The method of claim 1, wherein the method further comprises:
receiving a command to adjust a magnification of the target region; and
adjusting the magnification of the target region within the magnifier.

3. The method of claim 1, wherein the positioning information is received from a pointing device in the computer system, so that the pointing device can be used to position the magnifier within the computer display.

4. The method of claim 1, wherein the magnifier is a window that moves about the computer display.

5. The method of claim 4, wherein the magnifier is organized as a grid with nine regions, including:
a central region;
a top left region, which is above and to the left of the central region;
a top middle region, which is above the central region;
a top right region, which is above and to the right of the central region;
a middle left region, which is to the left of the central region;
a middle right region, which is to the right of the central region;
a bottom left region, which is below and to the left of the central region;
a bottom middle region, which is below the central region; and
a bottom right region, which is below and to the right of the central region.

6. The method of claim 5, wherein:
the central region magnifies in both the vertical and horizontal directions;
the top left region reduces in the vertical direction and reduces in the horizontal direction;
the top middle region reduces in the vertical direction and magnifies in the horizontal direction;
the top right region reduces in the vertical direction and reduces in the horizontal direction;
the middle left region magnifies in the vertical direction and reduces in the horizontal direction;
the middle right region magnifies in the vertical direction and reduces in the horizontal direction;
the bottom left region reduces in the vertical direction and reduces in the horizontal direction;
the bottom middle region reduces in the vertical direction and magnifies in the horizontal direction; and
the bottom right region reduces in the vertical direction and reduces in the horizontal direction.

7. The method of claim 5, wherein the magnifier additionally includes twelve peripheral regions, including:
a top left peripheral region, which is above the top left region;
a top middle peripheral region, which is above the top middle region;
a top right peripheral region, which is above the top right region;
a left top peripheral region, which is to the left of the top left region;
a left middle peripheral region, which is to the left of the middle left
a left bottom peripheral region, which is to the left of the bottom left region;
a right top peripheral region, which is to the right of the top right region;
a right middle peripheral region, which is to the right of the middle right region;
a right bottom peripheral region, which is to the right of the bottom right region;
a bottom left peripheral region, which is below the bottom left region;
a bottom middle peripheral region, which is below the bottom middle region; and
a bottom right peripheral region, which is below the bottom right region;

8. The method of claim 7, wherein:
the top left peripheral region reduces in the horizontal direction;
the top middle peripheral region magnifies in the horizontal direction;
the top right peripheral region reduces in the horizontal direction;
the left top peripheral region reduces in the vertical direction;
the left middle peripheral region magnifies in the vertical direction;
the left bottom peripheral region reduces in the vertical direction;
the right top peripheral region reduces in the vertical direction;
the right middle peripheral region magnifies in the vertical direction;
the right bottom peripheral region reduces in the vertical direction;
the bottom left peripheral region reduces in the horizontal direction;
the bottom middle peripheral region magnifies in the horizontal direction; and
the bottom right peripheral region reduces in the horizontal direction;
wherein the twelve peripheral regions do not magnify or reduce as much as the proximate regions.

9. The method of claim 1,
wherein displaying the target region involves invoking a display method of an object associated with the target region; and
wherein the display method uses a magnification transformation to magnify the target region.

10. The method of claim 1, further comprising:
receiving positioning information for a second magnifier from the user of the computer system; and
positioning the second magnifier over a second target region in the computer display to magnify the second target region.

11. A computer-readable storage medium storing instructions that when executed by a computer system cause the computer system to perform a method for selectively magnifying a region within a computer display without obscuring proximate regions in the computer display, the method comprising:
receiving positioning information from a user of the computer system;
wherein the positioning information determines a position of a magnifier within the computer display;
wherein the magnifier covers a target region to be magnified and proximate regions immediately surrounding the target region;
positioning the magnifier over the target region and the proximate regions in the computer display;
displaying the target region within the magnifier in magnified form;
displaying the proximate regions within the magnifier in reduced and/or partially magnified form, so that features within the proximate regions are not obscured by the magnifier; and
displaying regions within the computer display not covered by the magnifier in unmodified form.

12. The computer-readable storage medium of claim 11, wherein the method further comprises:
receiving a command to adjust a magnification of the target region; and
adjusting the magnification of the target region within the magnifier.

13. The computer-readable storage medium of claim 11, wherein the positioning information is received from a pointing device in the computer system, so that the pointing device can be used to position the magnifier within the computer display.

14. The computer-readable storage medium of claim 11, wherein the magnifier is a window that moves about the computer display.

15. The computer-readable storage medium of claim 14, wherein the magnifier is organized as a grid with nine regions, including:
a central region;
a top left region, which is above and to the left of the central region;
a top middle region, which is above the central region;
a top right region, which is above and to the right of the central region;
a middle left region, which is to the left of the central region;
a middle right region, which is to the right of the central region;
a bottom left region, which is below and to the left of the central region;
a bottom middle region, which is below the central region; and
a bottom right region, which is below and to the right of the central region.

16. The computer-readable storage medium of claim 15, wherein:
the central region magnifies in both the vertical and horizontal directions;
the top left region reduces in the vertical direction and reduces in the horizontal direction;
the top middle region reduces in the vertical direction and magnifies in the horizontal direction;
the top right region reduces in the vertical direction and reduces in the horizontal direction;
the middle left region magnifies in the vertical direction and reduces in the horizontal direction;
the middle right region magnifies in the vertical direction and reduces in the horizontal direction;
the bottom left region reduces in the vertical direction and reduces in the horizontal direction;
the bottom middle region reduces in the vertical direction and magnifies in the horizontal direction; and
the bottom right region reduces in the vertical direction and reduces in the horizontal direction.

17. The computer-readable storage medium of claim 15, wherein the magnifier additionally includes twelve peripheral regions, including:
a top left peripheral region, which is above the top left region;
a top middle peripheral region, which is above the top middle region;
a top right peripheral region, which is above the top right region;
a left top peripheral region, which is to the left of the top left region;
a left middle peripheral region, which is to the left of the middle left region;
a left bottom peripheral region, which is to the left of the bottom left region;
a right top peripheral region, which is to the right of the top right region;
a right middle peripheral region, which is to the right of the middle right region;
a right bottom peripheral region, which is to the right of the bottom right region;
a bottom left peripheral region, which is below the bottom left region;
a bottom middle peripheral region, which is below the bottom middle region; and
a bottom right peripheral region, which is below the bottom right region;

18. The computer-readable storage medium of claim 17, wherein:
the top left peripheral region reduces in the horizontal direction;
the top middle peripheral region magnifies in the horizontal direction;
the top right peripheral region reduces in the horizontal direction;
the left top peripheral region reduces in the vertical direction;
the left middle peripheral region magnifies in the vertical direction;
the left bottom peripheral region reduces in the vertical direction;
the right top peripheral region reduces in the vertical direction;
the right middle peripheral region magnifies in the vertical direction;
the right bottom peripheral region reduces in the vertical direction;
the bottom left peripheral region reduces in the horizontal direction;
the bottom middle peripheral region magnifies in the horizontal direction; and
the bottom right peripheral region reduces in the horizontal direction;
wherein the twelve peripheral regions do not magnify or reduce as much as the proximate regions.

19. The computer-readable storage medium of claim 11,
wherein displaying the target region involves invoking a display method of an object associated with the target region; and
wherein the display method uses a magnification transformation to magnify the target region.

20. The computer-readable storage medium of claim 11, wherein the method further comprises:
receiving positioning information for a second magnifier from the user of the computer system; and
positioning the second magnifier over a second target region in the computer display to magnify the second target region.

21. An apparatus that selectively magnifies a region within a computer display without obscuring proximate regions in the computer display, comprising:
the computer display within a computer system;
a magnifier within the computer display;
an input device that is configured to receive positioning information from a user of the computer system;
wherein the positioning information determines a position of the magnifier within the computer display;
wherein the magnifier covers a target region to be magnified and proximate regions immediately surrounding the target region;
a positioning mechanism that is configured to position the magnifier over the target region and the proximate regions in the computer display; and
a display generation mechanism that is configured to,
display the target region within the magnifier in magnified form,
display the proximate regions within the magnifier in reduced and/or partially magnified form, so that features within the proximate regions are not obscured by the magnifier, and to
display regions within the computer display not covered by the magnifier in unmodified form.

22. The apparatus of claim 21, wherein the apparatus further comprises an adjustment mechanism that is configured to:
receive a command to adjust a magnification of the target region; and to adjust the magnification of the target region within the magnifier.

23. The apparatus of claim 21, wherein the input device is a pointing device in the computer system, whereby the pointing device can be used to position the magnifier within the computer display.

24. The apparatus of claim 21, wherein the magnifier is a window that moves about the computer display.

25. The apparatus of claim 24, wherein the magnifier is organized as a grid with nine regions, including:
a central region;
a top left region, which is above and to the left of the central region;
a top middle region, which is above the central region;
a top right region, which is above and to the right of the central region;
a middle left region, which is to the left of the central region;
a middle right region, which is to the right of the central region;
a bottom left region, which is below and to the left of the central region;
a bottom middle region, which is below the central region; and
a bottom right region, which is below and to the right of the central region.

26. The apparatus of claim 25, wherein:
the central region magnifies in both the vertical and horizontal directions;
the top left region reduces in the vertical direction and reduces in the horizontal direction;
the top middle region reduces in the vertical direction and magnifies in the horizontal direction;
the top right region reduces in the vertical direction and reduces in the horizontal direction;
the middle left region magnifies in the vertical direction and reduces in the horizontal direction;
the middle right region magnifies in the vertical direction and reduces in the horizontal direction;
the bottom left region reduces in the vertical direction and reduces in the horizontal direction;
the bottom middle region reduces in the vertical direction and magnifies in the horizontal direction; and
the bottom right region reduces in the vertical direction and reduces in the horizontal direction.

27. The apparatus of claim 25, wherein the magnifier additionally includes twelve peripheral regions, including:
a top left peripheral region, which is above the top left region;
a top middle peripheral region, which is above the top middle region;
a top right peripheral region, which is above the top right region;
a left top peripheral region, which is to the left of the top left region;
a left middle peripheral region, which is to the left of the middle left region;
a left bottom peripheral region, which is to the left of the bottom left region;
a right top peripheral region, which is to the right of the top right region;
a right middle peripheral region, which is to the right of the middle right region;
a right bottom peripheral region, which is to the right of the bottom right region;
a bottom left peripheral region, which is below the bottom left region;
a bottom middle peripheral region, which is below the bottom middle region; and
a bottom right peripheral region, which is below the bottom right region;

28. The apparatus of claim 27, wherein:
the top left peripheral region reduces in the horizontal direction;
the top middle peripheral region magnifies in the horizontal direction;
the top right peripheral region reduces in the horizontal direction;
the left top peripheral region reduces in the vertical direction;
the left middle peripheral region magnifies in the vertical direction;
the left bottom peripheral region reduces in the vertical direction;
the right top peripheral region reduces in the vertical direction;
the right middle peripheral region magnifies in the vertical direction;
the right bottom peripheral region reduces in the vertical direction;
the bottom left peripheral region reduces in the horizontal direction;
the bottom middle peripheral region magnifies in the horizontal direction; and
the bottom right peripheral region reduces in the horizontal direction;
wherein the twelve peripheral regions do not magnify or reduce as much as the proximate regions.

29. The apparatus of claim 21,
wherein the display generation mechanism is configured to display the target region by invoking a display method of an object associated with the target region; and
wherein the display method is configured to use a magnification transformation to magnify the target region.

30. The apparatus of claim 21, wherein the positioning information is additionally configured to:
receive positioning information for a second magnifier from the user of the computer system; and to
position the second magnifier over a second target region in the computer display to magnify the second target region.

31. A method for selectively magnifying a region within a computer display without obscuring proximate regions in the computer display, comprising:
receiving positioning information from a user of a computer system;
wherein the positioning information determines a position of a magnifier within the computer display;
wherein the magnifier covers a target region to be magnified and proximate regions immediately surrounding the target region;
positioning the magnifier over the target region and the proximate regions in the computer display; and
displaying the target region within the magnifier so that every point in the target region is mapped to a point within the magnifier, and at least one portion of the target region is magnified.

32. A computer-readable storage medium storing instructions that when executed by a computer system cause the computer system to perform a method for selectively magnifying a region within a computer display without obscuring proximate regions in the computer display, the method comprising:
receiving positioning information from a user of the computer system;
wherein the positioning information determines a position of a magnifier within the computer display;
wherein the magnifier covers a target region to be magnified and proximate regions immediately surrounding the target region;
positioning the magnifier over the target region and the proximate regions in the computer display; and
displaying the target region within the magnifier so that every point in the target region is mapped to a point within the magnifier, and at least one portion of the target region is magnified.

33. An apparatus that selectively magnifies a region within a computer display without obscuring proximate regions in the computer display, comprising:
the computer display within a computer system;
a magnifier within the computer display;
an input device that is configured to receive positioning information from a user of the computer system;
wherein the positioning information determines a position of the magnifier within the computer display;
wherein the magnifier covers a target region to be magnified and proximate regions immediately surrounding the target region;
a positioning mechanism that is configured to position the magnifier over the target region and the proximate regions in the computer display; and
a display generation mechanism that is configured to, display the target region within the magnifier so that every point in the target region is mapped to a point within the magnifier, and at least one portion of the target region is magnified.
